(19) United States
(12) Patent Application Publication
(10) Pub. No.: US 2007/0027708 A1
(43) Pub. Date: Feb. 1, 2007

(54) Systems and methods to facilitate rental transactions

(75) Inventors: Daniel Stephan Brown, Los Gatos, CA (US); Kevin Scot Taylor, San Jose, CA (US)

Correspondence Address: CARR & FERRELL LLP, 2200 GENG ROAD, PALO ALTO, CA, 94303, US

(73) Assignee: RentalMetro, Inc. d/b/a NuvoRent

(21) Appl. No.: 11/495,198

(22) Filed: Jul. 28, 2006

Related U.S. Application Data
(60) Provisional application No. 60/595,738, filed on Aug. 1, 2005.

(51) Int. Cl. G06Q 99/00

(52) U.S. Cl. 705/1

(57) ABSTRACT

Systems and methods for facilitating rental of a good comprising storing a good identifier associated with the good in a product database, displaying product information associated with the good based on a geographical location of the good, receiving a rental request from the renter, and sending a contact information associated with the renter to a listing party at least in part based on the rental request. The rental request may be anonymous. An inquiry may be received from the renter and anonymized and sent to the listing party. An anonymous negotiation between a listing party and the renter may be conducted and the rental price and/or the rental term may be determined based on the anonymous negotiation.

### CROSS-REFERENCE TO RELATED APPLICATIONS

This application claims the benefit of U.S. Provisional Application Ser. No. 60/595,738 titled “Process for facilitating rental transactions for items and services between two or more parties using the Internet,” filed Aug. 1, 2005, which is hereby incorporated by reference.

### BACKGROUND OF THE INVENTION

1. Field of the Invention

The present invention relates generally to rental transactions, and more particularly to systems and methods to facilitate rental transactions.

2. Description of the Related Art

Individuals and businesses often have equipment that is underutilized and could be profitably rented to others. This equipment often sits unused in a garage, closet, or in a factory for many months of the year because there is no efficient, convenient, and practical way of making these goods available for rent to others.

Similarly, individuals or businesses can offer services that are underutilized and could be profitably provided or rented to others. For example, an individual may offer tutoring services or a handyman may offer repair services.

The widespread adoption of the Internet as a method of communication has improved the ability of renters to find goods and services they wish to rent by visiting a website. Some businesses operate websites that stock a single specialized product line, such as a car rental website offering cars for rent. One example of this kind of website is www.hertz.com (“Hertz”). However, these websites generally do not allow other individuals or businesses to list competing items on these websites, and the prospective renters may need to search multiple websites for the specific good they wish to rent or for the best rental price or rental terms.

Other existing websites providing rentals may function as bulletin boards, where individuals or businesses may post descriptions of the good they are offering for rent along with contact information. One example of this kind of website is www.craigslist.org (“Craigslist”). However, bulletin board websites are usually designed to arrange sales of goods, as contrasted with rental of goods. Further, the bulletin boards do not provide simple method to find goods on the website or find goods that are available to rent within a geographic area close to the renter.

### SUMMARY OF THE INVENTION

Systems and methods are provided to facilitate rental transactions. A software product for facilitating rental of a good can comprise software operational when executed by a processor to direct the processor to store a good identifier associated with the good in a product database, display product information associated with the good based on a geographical location of the good, receive a rental request from the renter, and send contact information associated with the renter to a listing party based at least in part on the rental request. The software can be stored in a storage medium and the good may comprise an article or a service.

In various embodiments the software can direct the processor to anonymize the rental request and display the anonymized rental request to the listing party. The software may also direct the processor to deliver an inquiry associated with the good from the renter to the listing party. The delivery of the inquiry may comprise receiving the inquiry from the renter, anonymizing the inquiry, and sending an anonymized inquiry to the listing party.

The software may also direct the processor to facilitate an anonymous negotiation between the listing party and the renter. The rental price and/or rental term may be determined based on the anonymous negotiation. Further, the software may direct processor to receive a quality rating associated with the good from the renter, store the quality rating within a rating database, and display the quality rating to another renter.

Various embodiments include a method for facilitating rental of a good comprising storing a good identifier associated with the good in a product database, displaying product information associated with the good based on a geographical location of the good, receiving a rental request from the renter, and sending contact information associated with the renter to a listing party based at least in part on the rental request. The rental request may be anonymized, and the anonymized rental request displayed to the listing party.

Anonymization of the rental requests, rental inquiries, and negotiation process protects the privacy of the listing party and the renter until a rental transaction has been accepted by the listing party. In addition, the anonymization provides assurance that the operator of the software product may collect a fee or commission from one or both of the listing party and the renter in exchange for the facilitation of the rental transaction and for the disclosure of the identities of the listing party and the renter.

### BRIEF DESCRIPTION OF THE DRAWINGS

FIG. 1 is a block diagram of a rental environment configured for facilitating a rental transaction in an exemplary embodiment of the invention.

FIG. 2 is a block diagram of a rental system in an exemplary embodiment of the invention.

FIG. 3 is a flow chart depicting the facilitation of a rental transaction in an exemplary embodiment of the invention.

FIG. 4 is a flow chart depicting the anonymization of a rental request in an exemplary embodiment of the invention.

FIG. 5 is a flow chart depicting the anonymization of a rental inquiry in an exemplary embodiment of the invention.

FIG. 6 is a flow chart depicting the facilitation of an anonymous negotiation in an exemplary embodiment of the invention.

FIG. 7 is a flow chart depicting processing of quality ratings in an exemplary embodiment of the invention.

FIG. 8 is a block diagram of a digital device in an exemplary embodiment of the invention.

### DETAILED DESCRIPTION OF THE INVENTION

The embodiments discussed herein are illustrative examples of the present invention. As these embodiments of the present invention are described with reference to illustrations, various modifications or adaptations of the systems, methods, and/or software product described may become apparent to those skilled in the art. All such modifications, adaptations, or variations that rely upon the teachings of the present invention, and through which these teachings have advanced the art, are considered to be within the scope of the present invention. Hence, these descriptions and drawings should not be considered in a limiting sense, as it is understood that the present invention is in no way limited to only the embodiments illustrated.

The present invention provides systems and methods for facilitating rental of a good. A good is any item or service that a listing party wishes to rent to a renter. In one example, a good may be an item such as a vehicle, tool, house, apartment, or facility (e.g., auditorium, satellite dish, or scientific equipment) that may be rented. In another example, a good may be a service, including painting or tutoring where in a renter is interested in receiving the service to perform one or more tasks. A listing party is any person or entity with one or more goods to rent. A renter is any person or entity that desires to rent the good.

In exemplary embodiments, systems and methods for facilitating rental of a good comprises a rental system that allows listing parties to list one or more items to be rented or services to be provided. Renters can access the rental system to find good. The rental system can facilitate a rental transaction between one or more listing parties and one or more renters by providing the system where goods can be found and rental transactions completed. In one example, the rental system comprises a website configured to allow the listing parties to list goods to rent, allow the renters to find the goods, and support rental transactions between the listing parties and the renters. A rental transaction is a transaction between the renter and the listing party for renting an item or performing a service.

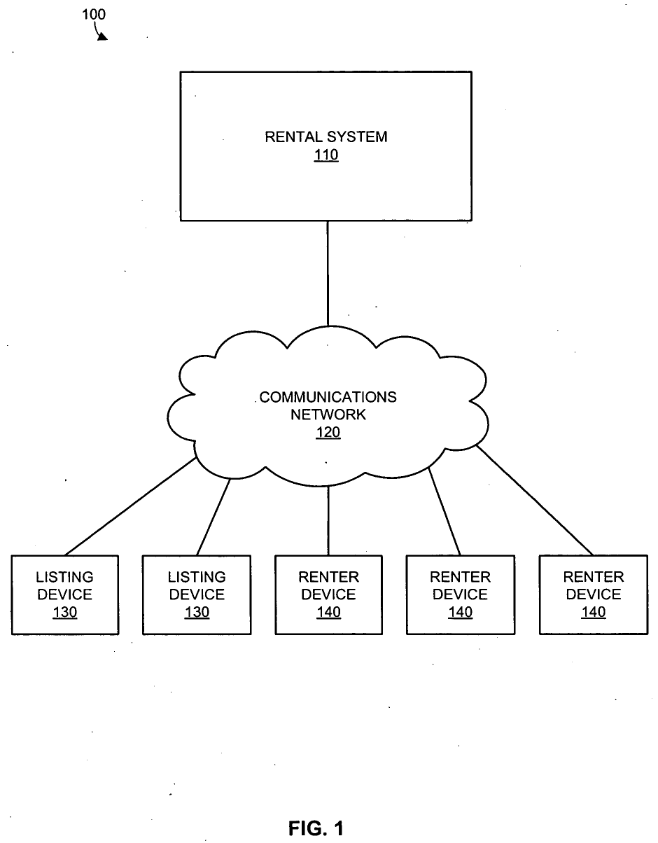

FIG. 1 is a block diagram of a rental environment 100 for facilitating a rental transaction in an exemplary embodiment of the invention. The rental environment 100 comprises a rental system 110, a communications network 120, listing devices 130, and renter devices 140. Although FIG. 1 depicts two listing devices 130 and three renter devices 140 for simplicity, there may be any number of listing devices 130 and renter devices 140.

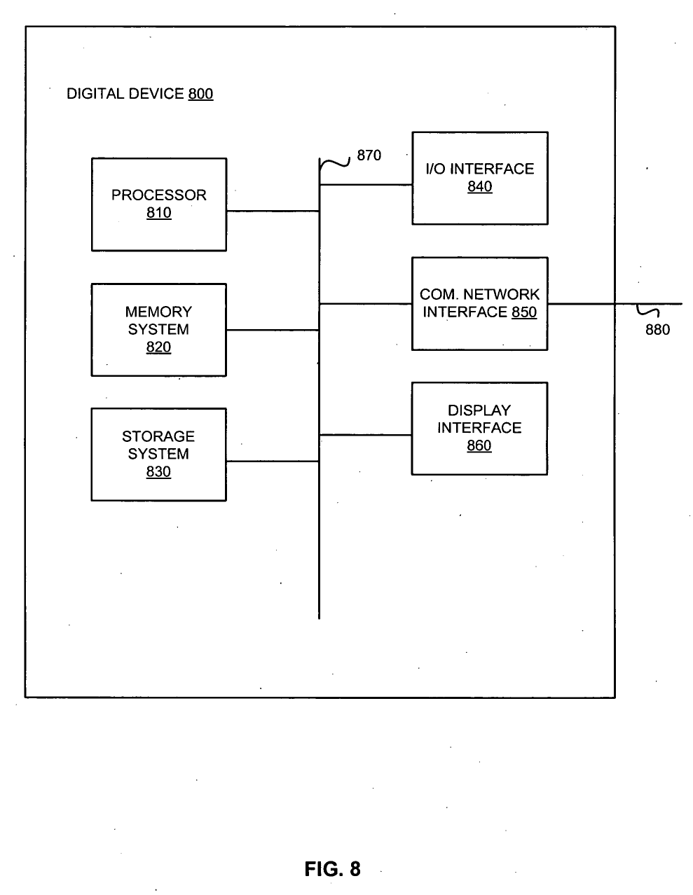

The rental system 110 may be any digital device with one or more processors, or more than one digital device that are coupled together. The rental system 110 is configured to facilitate rental transactions. A digital device is any device capable of storing and processing data (e.g., personal computer, personal digital device, cellular telephone.) Digital devices are further discussed in FIG. 8. In some embodiments, the rental system 110 hosts a website configured to facilitate rental transactions.

The rental system 110 is coupled to the communications network 120. The communications network 120 can be any network, including, but not limited to a telephone network or computer network (e.g., Internet, local area network, and/or wide area network).

Listing devices 130 can be coupled to the rental system 110 through the communications network 120. Listing devices 130 are any digital devices configured to communicate with the rental system 110 for the purpose of listing a good. Listing a good comprises the listing party making product information associated with the good available to a renter for the purpose of forming rental transactions. Product information comprises any information that describes the good, including pictures, graphical representations, or descriptions regarding the good, use of the good, the good's history, or the quality of the good.

In exemplary embodiments, two or more unrelated listing parties may list goods on the rental system 110. In some examples, the goods can be unrelated, competitive goods, or complementary goods. A listing party may list any number of goods on the rental system 110.

Renter devices 140 can also be coupled to the rental system 110 through the communications network 120. Renter devices 140 are any digital devices configured to allow the renter to communicate with the rental system 110 for the purposes of renting the goods (e.g., renting the item or purchasing the service) listed by the listing device 130. Any number of renter devices 140 may rent goods from the listing devices 130 over the rental system 110.

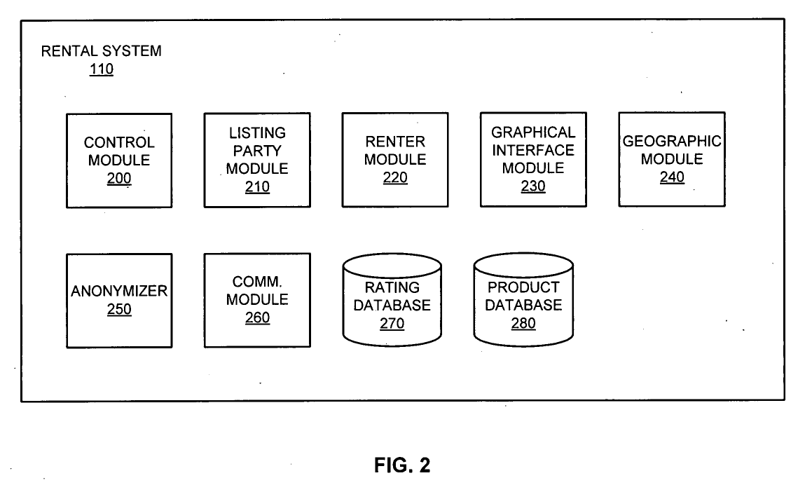

Referring to FIG. 2, a rental system 110 is described in an embodiment of the present invention. The rental system 110 comprises a control module 200, a listing party module 210, a renter module 220, a graphical interface module 230, a geographic module 240, an anonymizer 250, a communications module 260, a rating database 270, and a product database 280. The control module 200 is configured to control the rental system 110. In some embodiments, the control module 200 facilitates the renting of goods.

The listing party module 210 receives product information associated with the good from the listing device 130 (FIG. 1). In one example, the listing device 130 lists goods to be rented by transmitting product information such as pictures and descriptions of the good to the listing party module 210. The listing party module 210 may authenticate the listing device 130 and/or the listing party, store the product information within the product database 280 (further discussed herein), and generate a good identifier to identify the listed good.

The renter module 220 can register the renter, store personal information of the renter, authenticate renters (or renter devices 140), receive rental requests (further discussed herein), and receive rental inquiries (further discussed herein). The renter module 220 can also receive search requests for goods from the renter devices 140.

The graphical interface module 230 can be configured to display rental information to the listing devices 130 and the renter devices 140. In one example, the graphical interface module 230 controls a graphical user interface on a website that allows renter devices 140 to find goods (e.g., an item to rent or a service available for purchase). Further, the graphical interface module 230 can control a graphical user interface that allows listing devices 130 to upload product information and list the goods.

The optional geographic module 240 can determine the geographic location of the good, the listing party, and the renter. In one embodiment, the renter uses the renter device 140 to search a graphical user interface provided by the graphical interface module 230 to find a good (e.g., a cement mixer). In this example, the control module 200 can receive the search request and retrieve product information regarding different cement mixers available to rent from the product database 280 (further described herein.) The geographic module 240 may determine the distance between the renter and the cement mixer and provide approximate or exact distances to the renter device 140. The renter can then use the information to find the most convenient or closest cement mixer to rent.

The geographic location can comprise a specific or approximate address of the good, the listing party, and/or the renter. The geographic location can also comprise the distance or directions between the location of the good, the listing party, and/or the renter. The geographic module may store the geographic location within the product database 280 (further discussed herein) or any other data structure.

The optional anonymizer 250 can strip away personally identifying information from communications. Personally identifying information comprises addresses, names, phone numbers, email addresses, or any other information that would allow the listing party to directly contact the renter (or the renter directly contact the listing party) before the rental transaction is completed.

In exemplary embodiments, a facilitator may receive a fee or portion of the money involved in the rental transaction upon any agreement between the listing party and the renter. In other embodiments, the facilitator may receive a fee or portion of the money involved in the rental transaction upon the return of the rented item or completion of the service. A facilitator is any entity that may operate the rental system 110. Advantageously, by anonymizing the communications between the listing device 130 and the renter device 140, the listing party and the renter are prevented from completing the transaction agreement outside of the rental system 110 and avoiding paying the facilitator for providing the rental system 110 that allowed the listing party to meet the renter.

The communication module 260 controls the communication between the rental system 110 and the communications network 120, the listing device 130, and or the renter device 140.

The rating database 270 and the product database 280 can be any data structure configured to organize, store, and retain information. The rating database 270 can organize, store, and retain rating information. Rating information is information regarding the quality of the good, past experience with the listing party which lists the good, or past experience with the renter that rented the good.

In one example, the quality of each good may be rated on a scale. A high rating may suggest that the good is of high quality (e.g., “like new” if the good is an item or “highly professional” if the good is a service.) Alternatively, a low rating may suggest that the good is of poor quality.

Similarly, rating information can be used to indicate past experience with the listing party or a renter. In an example, a high rating for the listing party may indicate that the listing party is responsive to the needs of the renter, is available, provides good customer service, and lists high quality goods. A high rating for the renter may indicate that the renter is reliable, communicative, available, and punctual.

In various embodiments, the rating information can assist a renter in choosing a good for a particular use or a particular listing party. The rating information can also assist the listing party in agreeing to provide the good (e.g., rent the item or provide the service) to the renter.

In some embodiments, the rating information can alter the rent transaction. A good with a low rating may be available to the renter at a discount. A listing party with high ratings and high quality goods may charge more than other listing party with low ratings. In other embodiments, a listing party may require a down payment or collateral if the renter has too few ratings or the ratings are too low.

The rental system 110 can also offer rental insurance to the renter or the listing party. Rental insurance can protect against poor goods or a failure by one of the entities (e.g., the renter or the listing party) to honor the transaction agreement by, for example, failure to pay, failure to provide or pick up the item, failure to return the item, failure to perform the service, or failure to receive the service. The terms of the rental insurance may be pre-determined.

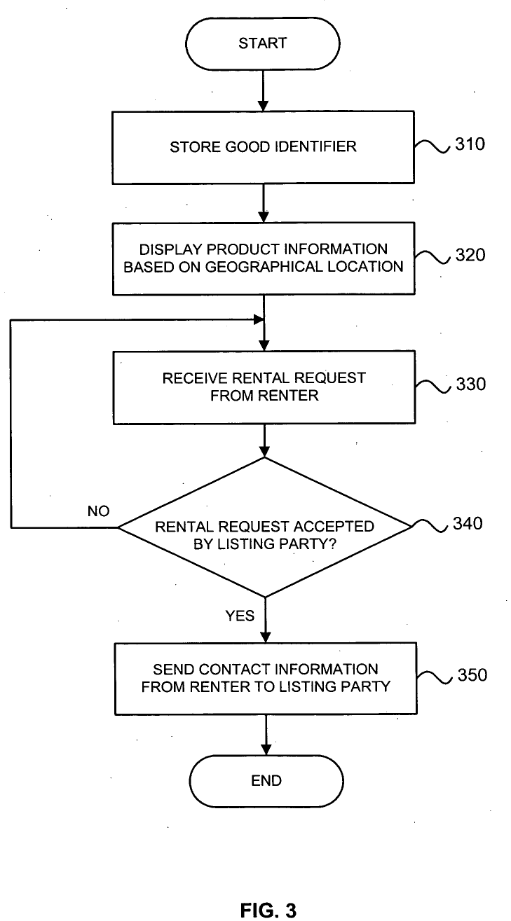

FIG. 3 is a flow chart depicting the facilitation of a rental transaction in an exemplary embodiment of the invention. In exemplary embodiments, the listing party and/or the renter may register their personal information within the rental system 110 (FIG. 1). In one example, the listing party is required to agree to the terms of service for using the rental system 110, and any transaction fees (herein discussed). The listing party may also provide financial information and/or personal information. Financial information can comprise a credit check, a bank account number, a credit card number, employer name, length of employment, salary, and/or references. Personal information may include, but is not limited to, name (personal or business name), email addresses, physical addresses, phone numbers and/or other contact information. In another example, prior to using the rental system 110, the renter can be required to agree to the terms of service for using the rental system 110 and any transaction fees. The renter may also provide personal information. In various embodiments, registration, or requiring the listing party and/or the renter to register before using the rental system 110, is optional.

In step 310, the listing party module 210 (FIG. 2) stores a good identifier within the product database 280 (FIG. 2). The good identifier is any identifier (e.g., serial number, model number, renter number) that identifies a good. The good identifier may be a unique number or any combination of numbers and/or letters. In one example, a listing party using a listing device 130 logs onto a rental system 110 comprising a web server. The listing party can then upload product information including the geographic location of the good (e.g., location of the item or geographic availability of the service). In some embodiments, the control module 200 (FIG. 2) generates a good identifier to identify the good within the rental system 110. In other embodiments, the listing device 130 provides the good identifier. In some embodiments, the product information, including the geographic location of the good, and the good identifier are stored within the product database 280.

In step 320, the graphical interface module 230 (FIG. 2) displays the product information based on geographical location. In exemplary embodiments, the display of the product information is based on the distance between the geographic location of the good or the distance between the good and the renter.

In one example, a renter device 140 accesses the rental system 110 through the Internet to search for a good. In some embodiments, the graphical interface module 230 provides and controls a search engine to allow a renter to locate the good. The renter device 140 may provide the rental system 110 with the geographic location of the renter. The geographic module 240 (FIG. 2) can then determine which goods of interest to the renter are within a predetermined distance of the geographic location of the renter, based on the geographic location of the good. The predetermined distance may be provided by the renter device 140. The control module 200 can retrieve the distance between the renter and the good and then command the graphical interface module 230 to display that distance within the search results. In exemplary embodiments, the graphical interface module 230 will only depict those goods to the user that are within the predetermined distance to the renter. Alternatively, the graphical interface module 230 can depict all goods of interest to the user regardless of distance between the good and the renter. In other embodiments, the graphical interface module 230 can depict the general location or a specific location of goods, renters, and/or listing parties.

In step 330, the control module 200 receives a rental request from the renter device 140. A rental request is a request from the renter for the good (e.g., to rent an item or purchase a service). The rental request may comprise the good identifier, a renter identifier, and transaction details. Transaction details can comprise the beginning date of the rental term, a desired duration of the rental term, a proposed price, and proposed terms of the transaction agreement.

In one example, the control module 200 receives the rental request and determines the good based on the good identifier within the rental request. If the good is available at the beginning date of the rental term and for the desire duration at the proposed price, the control module 200 can automatically agree to the rental request on behalf of the listing party in step 340.

In one example, if the desired item is available at the beginning date of the rental term and for the desired duration at the proposed price, the control module 200 can automatically agree to the rental request on behalf of the listing party. In another example, if the desired service is available at the beginning date of the rental term and for the desired duration at the proposed price, the control module 200 can automatically agree to the rental request.

Alternatively, the control module 200 can provide the request to the listing party (e.g., by providing the request to the listing device 130) that listed the desired good. Subsequently, the control module 200 may receive an agreement indicator from the listing device 130. An agreement indicator indicates that a transaction agreement can be made based on the rental request.

If no transaction agreement can be made or the good is unavailable, then the control module 200 may so indicate to the renter device 140 which may provide another rental request in step 330. The new rental request may comprise a different good identifier or different transaction details from the previous rental request.

If the listing device 130 indicates that the transaction agreement can be made or the control module 200 has automatically agreed to the rental request, the control module 200 can send contact information to the listing device 130. In one example, the control module 200 transmits the renter's name, address, telephone number, cellular number, and/or email address to the listing device 130. In other embodiments, the control module 200 transmits similar contact information of the listing party to the renter device 140. In further embodiments, the control module 200 or the geographic module 240 transmits a map or directions from the renter to the good or the listing device 130.

The control module 200 (or an accounting module not depicted) can charge a transaction fee. In some embodiments, the listing party is charged a fee once contact information is sent. The transaction fee may be a predetermined amount or a portion of the rental fee paid by the renter. In other embodiments, the renter is charged the fee. The transaction fee may also be a flat fee where the listing party is charged a single fee for listing the good on the rental system 110.

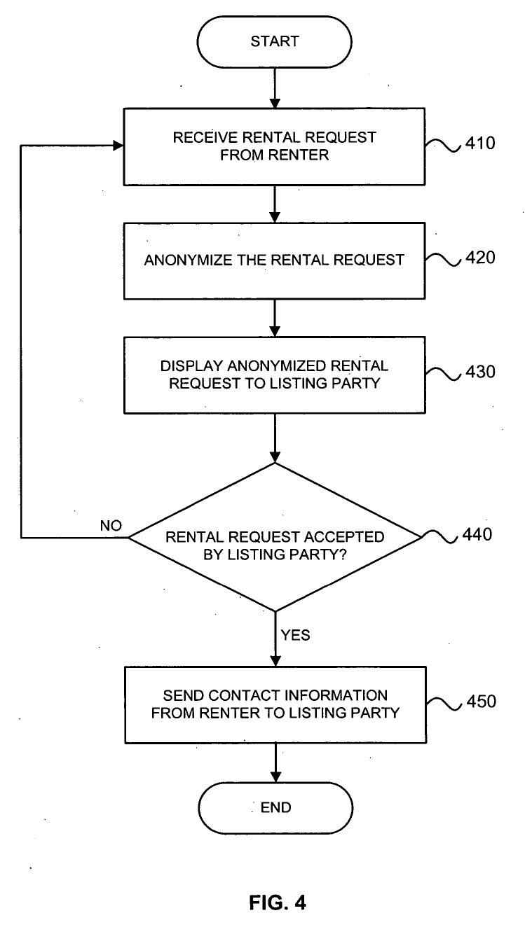

FIG. 4 is a flow chart depicting the anonymization of a rental request in an exemplary embodiment of the invention. In step 410, the control module 200 (FIG. 2) receives the rental request from the renter device 140 (FIG. 1). Similar to step 330 in FIG. 3, the rental request may comprise the good identifier, a renter identifier, and transaction details.

In step 420, the anonymizer 250 (FIG. 2) anonymizes the rental request. The anonymizer 250 can strip out the renter identifier or personal information from the rental request and replace it with a username or unique renter alias. In one example, the control module 200 stores the original rental request in a historical database (not depicted) and sends the rental request to the anonymizer 250. The anonymizer 250 can strip out the renter identifier, information provided to personally contact the renter, the location of the renter, or any other information that identifies the renter. The anonymizer 250 can also generate a unique renter alias or retrieve a renter username and place the unique renter alias or username within the renter request. The anonymizer 250 can subsequently provide the anonymized renter request to the control module 200.

In exemplary embodiments, neither the listing party nor the renter may directly contact each other until a rental transaction is completed. By anonymizing rental requests, the identity of the renter and the listing party are safeguarded. Similarly, any other communications between the listing device 130 (FIG. 1) and the renter device 140 may be anonymized. The anonymizing process protects the identities and privacy of the listing party and the renter until the rental transaction is agreed to. Moreover, the anonymizing process prevents the listing party and renter from communicating with each other to form the rental transaction and avoid paying a fee to the facilitator (not depicted) or the rental system 110 (FIG. 1).

In step 430, the graphical interface module 230 (FIG. 2) displays the anonymized rental request to the listing device 130. The control module 200 may retrieve the anonymized rental request from the anonymizer 250 and then command the graphical interface module 240 to display the anonymized rental request. The anonymized rental request may be sent directly to the listing device 130 in a communication (e.g., email or instant message) or display the anonymized rental request on a web site.

In step 440, the control module 200 determines if the rental request is accepted by the listing party. In some embodiments, the listing device 130 can configure the control module 200 to automatically accept rental requests that meet pre-determined renting conditions. The pre-determined renting conditions may comprise an expected rental price, beginning of rental term, availability of good, and the duration of rental term. If the control module 200 automatically accepts the rental request, the control module 200 provides the contact information of the renter to the listing device 130 in step 450. In other embodiments, the control module 200 may provide the anonymized rental request to the listing device 130 and then wait to receive an indication from the listing device 130, that the anonymized rental request is accepted.

If the control module 200 determines that the anonymized rental request is not agreed to (e.g., automatically or by receiving an indicator from the listing device 130 that the anonymized rental request is not agreed to), then the control module 200 may provide the refusal to the renter device 140. In one example, the renter device 140 accesses the rental system 110 which displays that the anonymized rental request has not been agreed. The control module 200 may then receive another rental request from the renter device 140 in step 410.

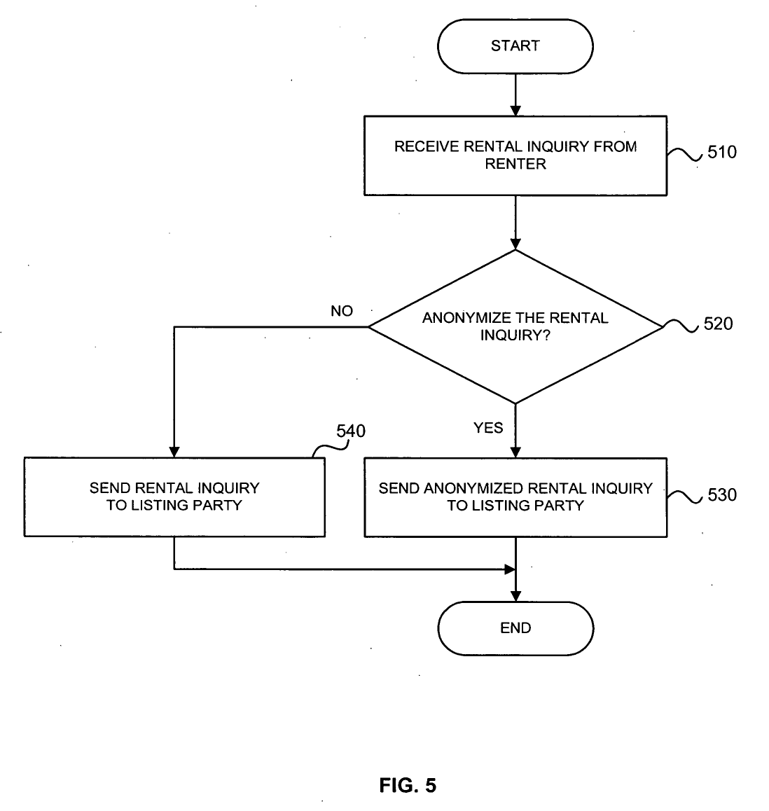

FIG. 5 is a flow chart depicting the anonymization of a rental inquiry in an exemplary embodiment of the invention. A rental inquiry is any question or proposed rental term related to the rental transaction. A proposed rental term is any term that may affect the rental transaction, including, but not limited to, price, duration of the rental, and/or beginning of the rental. In various embodiments, the renter device 140 (FIG. 1) and/or the listing device. 130 (FIG. 1) can send rental inquiries to each other to transmit questions pertinent to the rental transaction. By allowing rental inquiries between the renter device 140 and the listing device 130, the terms of the rental transaction can be changed or discussed to reach outcomes favorable to both the renter and listing party.

In step 510, the control module 200 (FIG. 2) receives a rental inquiry from the renter device 140. The renter device 140 can transmit the rental inquiry within any kind of message including, but not limited to, email, IM message, or SMS message. In some embodiments, the renter device 140 provides the rental inquiry to the rental system 110 on a web site (e.g., bulletin board). Once the control module 200 receives the rental inquiry, the control module 200 determines if the rental inquiry is to be anonymized in step 520.

In some embodiments, if the rental inquiry contains information that identifies the renter or the listing party, and the rental transaction has not yet been agreed to, then the control module 200 provides the rental inquiry to the anonymizer 250. The anonymizer 250 (FIG. 2) can receive the rental inquiry, remove identifying information, and provide a username or unique renter alias. The control module 200 can then provide the anonymized rental inquiry to the listing device 130 in step 530.

Alternatively, if the rental inquiry does not contain information that identifies the renter or the listing party, or the rental transaction has been agreed to, then the control module 200 may determine that anonymizing the rental inquiry is unnecessary. As a result, the control module 200 may provide the not-anonymized rental inquiry to the listing party in step 540.

Although FIG. 5 describes the rental inquiry being received from the renter device 140, the rental inquiry may be received from the listing device 130. In one example, the rental inquiry received from the listing device 130 is anonymized by the anonymizer 250 before being provided to the renter device 140.

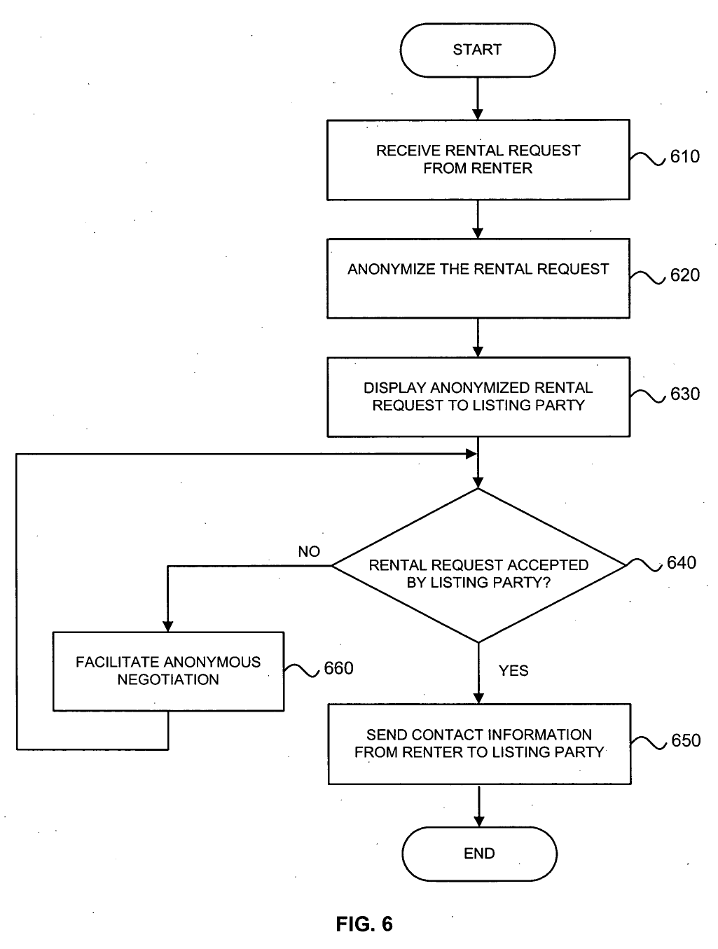

FIG. 6 is a flow chart depicting the facilitation of an anonymous negotiation in an exemplary embodiment of the invention. The renter and the listing party may enter into anonymous negotiation to alter or establish rental terms before the renter and the listing party agree to the rental transaction. In some embodiments, the rental system 110 (FIG. 1) provides a web site, email address, bulletin board, or other medium in which the renter device 140 (FIG. 1) and the listing device 130 (FIG. 1) can exchange information. Messages (e.g., rental inquires) may be anonymized prior to being provided or transmitted to the renter device 140 or the listing device 130.

In step 610, the control module 200 (FIG. 2) receives the rental request from the renter device 140. The control module 200 can provide the rental request to the anonymizer 250 (FIG. 2) to anonymize the rental request. The anonymizer 250 can anonymize the rental request and, subsequently, the graphical interface module 230 displays the anonymized rental request in step 630.

In step 640, the control module 200 determines if the rental request is accepted by the listing party. If the rental request is accepted, the control module 200 provides contact information of the renter to the listing party in step 650. If the renter request is not accepted, then the control module 200 can facilitate anonymous negotiation between the renter and the listing party in step 660.

The anonymous negotiation comprises sending and/or receiving one or more anonymous rental inquiries and/or one or more anonymized rental requests between the renter device 140 and the listing device 130. In one example, the control module 200 provides an email address to which the renter and the listing party can send rental requests and/or rental inquiries. The control module 200 can receive the email comprising the rental requests and/or rental inquires, anonymize the messages, and transmit them to the correct entity (e.g., the renter device 140 or the listing device 130).

In other embodiments, the rental system 110 comprises a bulletin board system, IM message system, or any other message system with which the renter device 140 and/or the listing device 130 can transmit rental requests and/or rental inquiries. In one example, the renter (e.g., via the renter device 140) inputs an anonymous rental inquiry directly into the bulletin board system which is then provided to the listing device 130. In some embodiments, the renter agrees to post all rental requests and rental inquires anonymously. In other embodiments, each rental request and rental inquiry is reviewed for identifying information. If identifying information is found, the anonymizer 250 can anonymize the message before providing the message to the other entity.

In some embodiments, the control module 200 determines a rental term. In one example, the control module 200 determines when the desired good is available and commands the graphical interface module 230 (FIG. 2) to depict a calendar to allow the renter a choice of dates. In other embodiments, the renter module 200 receives the desired term from the renter device 140 and determines a term that best fits the renter's needs. In further embodiments, the control module 200 transmits rental inquiries between the renter device 140 and the listing device 130 until a rental term is agreed upon.

In other embodiments, the control module 200 determines a rental price. In one example, the control module 200 determines at what rental price the desired good is available and commands the graphical interface module 230. In other embodiments, the renter module 200 receives a range of prices the listing party would accept and the desired price from the renter device 140 before determining a rental price for the rental transaction. In other embodiments, the control module 200 transmits rental inquiries between the renter device 140 and the listing device 130 until a rental price is agreed upon.

After the rental price and the rental term are agreed upon, the control module 200 determines if a new rental request has been accepted by the listing party in step 640. If the new rental request is not agreed upon, the anonymous negotiation process can continue in step 660.

Although rental term and rental price are associated with negotiation in FIG. 6, all terms related to the good and the rental transaction can be negotiated through anonymous negotiation. Further, in some embodiments, the control module 200 can facilitate anonymous negotiation between one or more renter devices 140 and one or more listing devices 130.

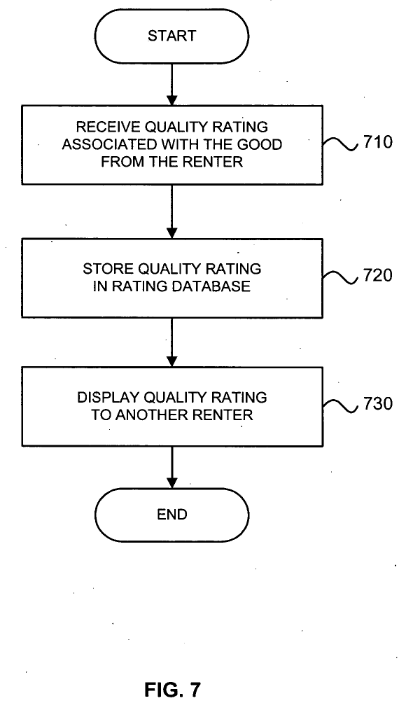

FIG. 7 is a flow chart depicting processing of quality ratings in an exemplary embodiment of the invention. In step 710, the control module 200 receives a quality rating associated with the good from the renter. In one example, after the rental transaction is concluded and the rented good returned; the control module 200 allows the renter to send a quality rating (e.g., via the renter device 140 (FIG. 1)) associated with the good and/or a quality rating associated with the listing party. In various embodiments, after the rental transaction is completed, the control module 200 allows both the renter and the listing party to leave a quality rating regarding the other entity and the experience with the rental.

In step 720, the control module 200 (FIG. 2) stores the quality rating received from the renter device 140 in the rating database 270 (FIG. 2). In some embodiments, the control module 200 quantitatively adds the quality rating to other to determine an average (e.g., mean or median) quality for the renter, good, and/or the listing party. Any form of analysis may be performed using the quality ratings.

In step 730, the control module 200 commands the graphical interface module 230 (FIG. 2) to display the quality rating of the renter, the good, or the listing party as well as any averages or other analysis. In one example, the graphical interface module 230 allows each renter, good, and listing party to be reviewed and their quality ratings evaluated. In some embodiments, different renters, goods, and listing parties can be compared by quality rating.

Although FIG. 7 describes receiving quality ratings, the control module 200 can also command the graphical interface module 230 to provide an interface to input a quality as well as a message or description describing the experience or the rating. The message may also be displayed to others.

FIG. 8 is a block diagram of the digital device 800 in an exemplary implementation of the invention. The digital device 800 comprises a processor 810, a memory system 820, a storage system 830, an input/output (“I/O”) interface 840, a communication network interface 850, and a display interface 860 which are all coupled to a system bus 870. The processor 810 is configured to execute executable instructions. In some embodiments, the processor 810 comprises circuitry or any processor capable of processing the executable instructions.

The memory system 820 is any memory configured to store data. Some examples of the memory 820 are storage devices, such as RAM or ROM. The storage system 830 is any storage configured to retrieve and store data. Some examples of the storage system 830 are flash drives, hard drives, optical drives, and/or magnetic tape. The storage system 830 can comprise the rating database 270 (FIG. 2) and the product database 280 (FIG. 2) or other data structure configured to hold and organize data. In some embodiments, the digital device 800 includes the memory system 820 in the form of RAM and the storage system 830 in the form of flash data.

The I/O interface 840 is any device that can receive input from the listing device 130 (FIG. 1,) the renter device 140 (FIG. 1), rental system 110 (FIG. 1), and/or the facilitator (not depicted). The I/O interface 840 can couple to a keyboard, touchscreen, mouse, keypad, printer, scanner, or any other input or output device.

The communication network interface 850 can be coupled to the communications network 120 (FIG. 1) via the link 880. Moreover, the communication network interface 850 may support communication over many kind of connections, including, but not limited to, a USB connection, a firewire connection, an Ethernet connection, a serial connection, a parallel connection, an ATA connection. The communication network interface 850 may also support wireless communication (e.g., 802.11 a/b/g/n or wireless USB). It will be apparent to those skilled in the art that the communication network interface 850 can support many wired and wireless standards.

The display interface 860 is any device that can control a display device. A display device can be a monitor, screen, LCD, flatscreen, or any device configured to display information. In some embodiments, the display interface 860 is controlled by the graphical interface module 230 (FIG. 2).

The above-described functions can be comprised of instructions that are stored on a storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with the invention. Those skilled in the art are familiar with instructions, processor(s), and storage medium.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A software product for facilitating rental of a good, the software product comprising:
software operational when executed by a processor to direct the processor to store a good identifier associated with the good in a product database, display product information associated with the good based on a geographical location of the good, receive a rental request from the renter, and send contact information associated with the renter to a listing party based at least in part on the rental request; and
a storage medium configured to store the software.

2. The software product of claim 1 wherein the software is further operational when executed by the processor to anonymize the rental request and display an anonymized rental request to the listing party.

3. The software product of claim 1 wherein the software is further operational when executed by the processor to deliver an inquiry associated with the good from the renter to the listing party.

4. The software product of claim 3 wherein delivery of the inquiry comprises:
receiving the inquiry from the renter;
anonymizing the inquiry; and
sending an anonymized inquiry to the listing party.

5. The software product of claim 1 wherein the software is operational when further executed by the processor to facilitate an anonymous negotiation between the listing party and the renter.

6. The software product of claim 5 wherein a rental price is determined based on the anonymous negotiation.

7. The software product of claim 5 wherein a rental term is determined based on the anonymous negotiation.

8. The software product of claim 1 where in the software is further operational when executed by the processor to:
receive a quality rating associated with the good from the renter;
store the quality rating within a rating database; and
display the quality rating to another renter.

9. The software product of claim 1 wherein the good comprises an article or a service.

10. A method for facilitating rental of a good, the method comprising:
storing a good identifier associated with the good in a product database;
displaying product information associated with the good based on a geographical location of the good;
receiving a rental request from the renter; and
sending contact information associated with the renter to a listing party based at least in part on the rental request.

11. The method of claim 10 further comprising anonymizing the rental request and displaying an anonymized rental request to the listing party.

12. The method of claim 10 further comprising delivering an inquiry associated with the good from the renter to the listing party.

13. The method of claim 12 wherein delivering the inquiry comprises:
receiving the inquiry from the renter;
anonymizing the inquiry; and
sending an anonymized inquiry to the listing party.

14. The method of claim 10 further comprising facilitating an anonymous negotiation between a listing party and the renter.

15. The method of claim 14 wherein a rental price is determined based on the anonymous negotiation.

16. The method of claim 14 wherein a rental term is determined based on the anonymous negotiation.

17. The method of claim 10 further comprising:
receiving a quality rating associated with the good from the renter;
storing the quality rating within a rating database; and
displaying the quality rating to another renter.

18. The method of claim 10 wherein the good comprises an article or a service.

19. A system for facilitating rental of a good on a communications network, the system comprising:
a communications interface configured to communicate over the communications network;
a storage device; and
a processor coupled to the communications network and the storage device, the processor configured to store a good identifier associated with the good in a product database, display product information associated with the good based on a geographical location of the good, receive a rental request from the renter, and send a contact information associated with the renter to a listing party at least in part based on the rental request.
